(19) United States
(12) Patent Application Publication
(10) Pub. No.: US 2026/0019922 A1
(43) Pub. Date: Jan. 15, 2026

(54) ACCESS RESTRICTION IN AN ENERGY SAVING NETWORK

(71) Applicant: LENOVO (BEIJING) LIMITED, Beijing (CN)

(72) Inventors: Ran YUE, Beijing (CN); Lianhai WU, Beijing (CN); Haiming WANG, Beijing (CN); Zhi YAN, Beijing (CN); Jie HU, Beijing (CN)

(21) Appl. No.: 18/875,612

(22) PCT Filed: Jun. 17, 2022
(86) PCT No.: PCT/CN2022/099491

§ 371 Date: Dec. 16, 2024

(51) Int. Cl. H04W 48/02; H04W 36/00; H04W 48/12

(52) U.S. Cl. CPC H04W 48/02; H04W 36/0033; H04W 48/12

(57) ABSTRACT

Methods and apparatuses for access restriction in an energy saving network are disclosed. In one embodiment, a UE comprises a processor; and a transceiver coupled to the processor, wherein, the processor is configured to receive, via the transceiver, at least one of access related information of a new cell and an indication of the cell status of the new cell; and perform an access restriction to the new cell based on the at least one of the access related information of the new cell and the indication of the cell status of the new cell.

### FIELD

The subject matter disclosed herein generally relates to wireless communications, and more particularly relates to methods and apparatuses for access restriction in an energy saving network.

### BACKGROUND

The following abbreviations are herewith defined, at least some of which are referred to within the following description: New Radio (NR), Very Large Scale Integration (VLSI), Random Access Memory (RAM), Read-Only Memory (ROM), Erasable Programmable Read-Only Memory (EPROM or Flash Memory), Compact Disc Read-Only Memory (CD-ROM), Local Area Network (LAN), Wide Area Network (WAN), User Equipment (UE), Evolved Node B (eNB), Next Generation Node B (gNB), Uplink (UL), Downlink (DL), Central Processing Unit (CPU), Graphics Processing Unit (GPU), Field Programmable Gate Array (FPGA), Orthogonal Frequency Division Multiplexing (OFDM), Radio Resource Control (RRC), User Entity/Equipment (Mobile Terminal), Transmitter (TX), Receiver (RX), master information block (MIB), synchronization signal block (SSB), system information block (SIB), unified access control (UAC), access category (AC), access identity (AI), network energy saving (NES), random access channel (RACH), information element (IE).

A UE that supports the feature of network energy saving (NES) techniques may be referred to as new UE. A UE that does not support the feature of network energy saving techniques may be referred to as legacy UE. A cell that supports the feature of network energy saving techniques may be referred to as new cell. A cell that does not support the feature of network energy saving techniques may be referred to as legacy cell.

The new cell may have different states, e.g. non-sleep state and multiple sleep states.

This invention targets the access control in an energy saving network, e.g. for a new UE and/or to a new cell.

### BRIEF SUMMARY

Methods and apparatuses for access restriction in an energy saving network are disclosed.

In one embodiment, a UE comprises a processor; and a transceiver coupled to the processor, wherein, the processor is configured to receive, via the transceiver, at least one of access related information of a new cell and an indication of the cell status of the new cell; and perform an access restriction to the new cell based on the at least one of the access related information of the new cell and the indication of the cell status of the new cell.

In some embodiment, the access related information of the new cell includes at least one of new AI, new AC, and new parameters defined in existing AI or AC for new UE.

In some embodiment, the UE is a new UE or a new UE without specific traffics.

In some embodiment, the indication of the cell status of the new cell includes at least one of an indication of the cell status of the new cell for legacy UE and an indication of the cell status of the new cell for new UE. If the new cell is not in normal state, or the new cell is not for access, or the new cell is a non-anchor cell, then, the cell status of the new cell for legacy UE is “barred” and the cell status of the new cell for new UE is “not barred”.

In some embodiment, if the indication of the cell status of the new cell is “not barred”, the access restriction to the new cell is performed based on the access related information of the new cell.

In some embodiment, the processor is further configured to receive, via the transceiver, at least one of a cell reselection indication for new UE and a cell reselection indication for legacy UE, the cell reselection indication for the new UE indicates, if the indication of the cell status of the new cell indicates “barred” for the new UE, whether the new UE is allowed to reselect other cells on the same frequency as the barred cell, and the cell reselection indication for the legacy UE indicates, if the indication of the cell status of the new cell indicates “barred” for the legacy UE, whether the legacy UE is allowed to reselect other cells on the same frequency as the barred cell.

In another embodiment, a method performed by a UE comprises receiving at least one of access related information of a new cell and an indication of the cell status of the new cell; and performing an access restriction to the new cell based on the at least one of the access related information of the new cell and the indication of the cell status of the new cell.

In still another embodiment, a base unit comprises a processor; and a transceiver coupled to the processor, wherein, the processor is configured to transmit, via the transceiver, to a UE, at least one of access related information of a new cell and an indication of the cell status of the new cell, wherein, an access restriction of the UE to the new cell is performed according to the at least one of the access related information of the new cell and the indication of the cell status of the new cell.

In some embodiment, the access related information of the new cell includes at least one of new AI, new AC, and new parameters defined in existing AI or AC for new UE.

In some embodiment, the access restriction of a new UE or a new UE without specific traffics to the new cell is performed.

In some embodiment, the indication of the cell status of the new cell includes at least one of an indication of the cell status of the new cell for legacy UE and an indication of the cell status of the new cell for new UE. If the new cell is not in normal state, or the new cell is not for access, or the new cell is a non-anchor cell, then, the cell status of the new cell for legacy UE is “barred” and the cell status of the new cell for new UE is “not barred”.

In some embodiment, different access control parameters are configured to access related information of the new cell depending on different states of the new cell.

In some embodiment, the processor is further configured to transmit, via the transceiver, to the UE, at least one of a cell reselection indication for new UE and a cell reselection indication for legacy UE, the cell reselection indication for the new UE indicates, if the indication of the cell status of the new cell indicates “barred” for the new UE, whether the new UE is allowed to reselect other cells on the same frequency as the barred cell, and the cell reselection indication for the legacy UE indicates, if the indication of the cell status of the new cell indicates “barred” for the legacy UE, whether the legacy UE is allowed to reselect other cells on the same frequency as the barred cell.

In yet another embodiment, a method performed by a base unit comprises transmitting, to a UE, at least one of access related information of a new cell and an indication of the cell status of the new cell, wherein, an access restriction of the UE to the new cell is performed according to the at least one of the access related information of the new cell and the indication of the cell status of the new cell.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 is a schematic flow chart diagram illustrating an embodiment of a method;

FIG. 2 is a schematic flow chart diagram illustrating a further embodiment of a method; and

FIG. 3 is a schematic block diagram illustrating apparatuses according to one embodiment.

### DETAILED DESCRIPTION

As will be appreciated by one skilled in the art that certain aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may generally all be referred to herein as a “circuit”, “module” or “system”. Furthermore, embodiments may take the form of a program product embodied in one or more computer readable storage devices storing machine-readable code, computer readable code, and/or program code, referred to hereafter as “code”. The storage devices may be tangible, non-transitory, and/or non-transmission. The storage devices may not embody signals. In a certain embodiment, the storage devices only employ signals for accessing code.

Certain functional units described in this specification may be labeled as “modules”, in order to more particularly emphasize their independent implementation. For example, a module may be implemented as a hardware circuit comprising custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but, may include disparate instructions stored in different locations which, when joined logically together, include the module and achieve the stated purpose for the module.

Indeed, a module of code may contain a single instruction, or many instructions, and may even be distributed over several different code segments, among different programs, and across several memory devices. Similarly, operational data may be identified and illustrated herein within modules and may be embodied in any suitable form and organized within any suitable type of data structure. This operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing code. The storage device may be, for example, but need not necessarily be, an electronic, magnetic, optical, electromagnetic, infrared, holographic, micromechanical, or semiconductor system, apparatus, or device, or any suitable combination of the foregoing.

A non-exhaustive list of more specific examples of the storage device would include the following: an electrical connection having one or more wires, a portable computer diskette, a hard disk, random access memory (RAM), read-only memory (ROM), erasable programmable read-only memory (EPROM or Flash Memory), portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Code for carrying out operations for embodiments may include any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may be executed entirely on the user's computer, partly on the user's computer, as a stand-alone software package, partly on the user's computer and partly on a remote computer or entirely on the remote computer or server. In the very last scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment”, “an embodiment”, or similar language means that a particular feature, structure, or characteristic described in connection with the embodiment is included in at least one embodiment. Thus, appearances of the phrases “in one embodiment”, “in an embodiment”, and similar language throughout this specification may, but do not necessarily, all refer to the same embodiment, but mean “one or more but not all embodiments” unless expressly specified otherwise. The terms “including”, “comprising”, “having”, and variations thereof mean “including but are not limited to”, unless otherwise expressly specified. An enumerated listing of items does not imply that any or all of the items are mutually exclusive, otherwise unless expressly specified. The terms “a”, “an”, and “the” also refer to “one or more” unless otherwise expressly specified.

Furthermore, described features, structures, or characteristics of various embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid any obscuring of aspects of an embodiment.

Aspects of different embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general purpose computer, special purpose computer, or other programmable data processing apparatus to produce a machine, such that the instructions, which are executed via the processor of the computer or other programmable data processing apparatus, create means for implementing the functions specified in the schematic flowchart diagrams and/or schematic block diagrams for the block or blocks.

The code may also be stored in a storage device that can direct a computer, other programmable data processing apparatus, or other devices, to function in a particular manner, such that the instructions stored in the storage device produce an article of manufacture including instructions which implement the function specified in the schematic flowchart diagrams and/or schematic block diagrams block or blocks.

The code may also be loaded onto a computer, other programmable data processing apparatus, or other devices, to cause a series of operational steps to be performed on the computer, other programmable apparatus or other devices to produce a computer implemented process such that the code executed on the computer or other programmable apparatus provides processes for implementing the functions specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that in some alternative implementations, the functions noted in the block may occur out of the order noted in the Figures. For example, two blocks shown in succession may substantially be executed concurrently, or the blocks may sometimes be executed in the reverse order, depending upon the functionality involved. Other steps and methods may be conceived that are equivalent in function, logic, or effect to one or more blocks, or portions thereof, to the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each Figure may refer to elements of proceeding figures. Like numbers refer to like elements in all figures, including alternate embodiments of like elements.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE, 3GPP NR-U, NR Radio Access operating with shared spectrum channel access and so on. It is contemplated that along with the developments of network architectures and new service scenarios, all embodiments in the present application are also applicable to similar technical problems. Moreover, the terminologies recited in the present application may change, which should not affect the principle of the present application. Embodiments of the present disclosure can also be applied to unlicensed spectrum scenario.

To make description clearer, a few concepts are clarified.

A UE, e.g. in idle (e.g. RRC_IDLE) state, camps on a cell. It means that the UE can receive system information broadcasted by the base unit (e.g. gNB) that manages the cell. A UE, e.g. in connected (e.g. RRC_CONNECTED) state, is served by at least one cell. It means that, for each of the at least one cell, the UE communicates with the gNB that manages the cell.

The new cell, which supports the feature of network energy saving techniques, may be in non-sleep state (e.g. normal state, active state, etc) or in sleep state. A new cell is in sleep state means the new cell is in the state of low energy consumption. There could be multiple sleep states, for example micro sleep state, light sleep state, deep sleep state, etc (note that the name of each sleep state may be different from micro sleep state, light sleep state, and/or deep sleep state. For example, multiple sleep states may alternatively be low level sleep state, medium level sleep state, high level sleep state, etc). Each of the sleep states corresponds to a different level of energy consumption. The different level of energy consumption may be represented by different state transition time, or by different reference parameters or different configurations or different configuration periods, or by different levels of TX power, or by different levels of power consumption, or by different levels of resource allocation, etc. Each of different levels may be less than 100%. A new cell is in non-sleep state means the new cell can utilize the full level of energy or the higher level of energy than that of the sleep state. Correspondingly, the state transition time, or TX power, or power consumption, or resource allocation, etc in non-sleep state can be less than or equal to 100% or can be higher than the level in sleep state.

Considering the compatibility with legacy cell and the support of multi-carrier in NR Release 18 network energy saving, there could be different deployment configurations listed in Table 1.

TABLE 1

| Case | deployment | Configuration of new cell |
|---|---|---|
| a-1 | (Legacy or) new | Cell #1: system information; |
| | cell #1 + new | in non-sleep state; |
| | cell #2 | Cell #2: SSB less or reduced SSB, |
| | | but MIB could be provided; |
| | | in sleep state; |
| a-2 | (Legacy or) new | Cell #1: system information; |
| | cell #1 + new | in non-sleep state; |
| | cell #2 | Cell #2: system information configured |
| | | with longer period; |
| | | in sleep state; |
| b | new cell #3 | Cell #3: system information; |
| | | for the legacy UEs or urgent traffics, |
| | | in non-sleep state; |
| | | for non-urgent traffics, in sleep state; |

In case (a) (i.e. case a-1 or case a-2), cell #1 (which is a legacy cell or new cell) and cell #2 (which is a new cell), that can be, for example, inter-frequency cells, provide coverage, e.g. for the same area or the cell #2 provides a smaller coverage. In both cases a-1 and a-2, cell #1 provides system information. In particular, cell #1 needs to provide related information of cell #2. It means that if cell #1 is a legacy cell, it should be updated to support the ability to provide related information of cell #2. In case a-1, cell #2 does not provide full access related information. For example, cell #2 provides neither MIB nor any SIB, or provides MIB but not any SIB. In the MIB and/or the SIBs (SIB1, etc) in case a-1, SSB may be not transmitted and/or received (i.e. SSB less), or the transmission and/or reception of SSB is reduced (i.e. reduced SSB) so that not full access related information is provided Reduced SSB can be implemented by increased periodicity, or by on-demand transmission and/or reception, or by occupying fewer symbols. On the other hand, in case a-2, cell #2 provides full access related information, e.g. with longer period of MIB and SIB1 and/or other SIBs. For case (a) (i.e. case a-1 or case a-2), the new cell #2, which is in one of the sleep states, can serve only new UEs.

In case (b), the cell #3, which is a new cell, can serve both new UEs and legacy UEs. In particular, the new cell #3 can be in non-sleep state when serving legacy UEs or new UEs with urgent traffics, and be in sleep state or low energy consumption mode when serving new UEs without urgent traffics.

It can be seen that for case (a-1) and especially for case (a-2), the reduced SSB from new cell #2 could be searched by the legacy UEs. However, the purpose of the deployment in case (a) is to serve the legacy UEs by the cell #1 and serve the new UEs by cell #2. So, it is better for the legacy UEs to be barred by the cell #2. However, such barring of the legacy UEs by new cell #2 cannot be achieved by existing cellBarred indication.

In addition, it can be assumed that the resources for transmission are different for legacy UEs and the new UEs in case (a-1) and (a-2) since new cell #2 is specified for new UEs. Since the signaling overhead could be relatively low considering the potential physical layer technologies for network energy saving (for example, aggregated scheduling and/or feedback signaling), relatively more new UEs can be served by the new cell. Accordingly, it is preferable to apply different access restrictions between new UEs and legacy UEs.

In legacy, there are mainly two mechanisms to impose cell reservations or access restrictions. The first mechanism uses indication of cell status (e.g. the indication of cellBarred in the master information block (MIB)). The second mechanism, referred to as Unified Access Control (UAC), allows preventing selected access categories (ACs) or access identities (Als) from sending initial access messages for load control reasons.

This disclosure proposes enhancements of the two mechanisms.

A first embodiment relates to enhancement of the first mechanism of indication of cell status.

In legacy first mechanism of indication of cell status, the cellBarred indication in MIB can be set to “barred” or “not barred”. When the UE receives the MIB, if the cellBarred indication in the received MIB is set to “barred”, the UE considers that the cell as barred. It means that the UE is not allowed to select (or reselect) the cell, which means that the UE shall select other cells. When selecting the other cell, if the intraFreqReselection indication in the received MIB is set to “notAllowed”, the UE considers that cell re-selection to other cells on the same frequency as the barred cell is not allowed (that is, the UE shall select other cells on a different frequency).

A first sub-embodiment of the first embodiment relates to enhancement of the indication of a cell not being allowed to access.

As described in the above, the legacy cellBarred indication can be used to bar the cell. In particular, the legacy UE can receive and identify the legacy cellBarred indication. If the cellBarred is set to “barred”, the legacy UE identifies that the cell is barred; and if the cellBarred is set to “not barred”, the legacy UE identifies that the cell is not barred.

According to the first sub-embodiment of the first embodiment, a new notallowed-NES indication can be added for the new UEs. The notallowed-NES indication can be in MIB, or SIB1 or other SIBs. The notallowed-NES indication can be set to “true” (or “barred”, “forbidden”, etc, that represents the cell is barred) which means the cell is barred (i.e. not allowed to access), or set to “false” (or “not barred” etc, that represents the cell is not barred) which means the cell is not barred (i.e. allowed to access). The notallowed-NES indication can be applied to all new UEs or only to new UEs without specific traffics. The specific traffics can be pre-defined or pre-configured. For example, the specific traffics can be latency critical traffics. UEs without latency critical traffics may mean new UEs that do not support latency critical traffics, or new UEs at which latency critical traffics do not arrive.

The new notallowed-NES indication can be used along with legacy cellBarred indication to indicate the cell status to both legacy UE and new UE, as explained in Table 2.

TABLE 2

| cellBarred | notallowed-NES | cell status | cell status |
|---|---|---|---|
| indication | indication | to legacy UE | to new UE |
| “barred” | “true” | cell is barred | cell is barred |
| “barred” | “false” | cell is barred | cell is not barred |
| “not barred” | “true” | cell is not barred | cell is barred |
| “not barred” | “false” | cell is not barred | cell is not barred |

In particular, the legacy UE can receive and identify the legacy cellBarred indication (while the legacy UE does not identify the notallowed-NES indication and accordingly ignores the received notallowed-NES indication). If the cellBarred is set to “barred”, the legacy UE identifies that the cell is barred, e.g. for the legacy UE; and if the cellBarred is set to “not barred”, the legacy UE identifies that the cell is not barred, e.g. for the legacy UE. On the other hand, the new UE can receive and identify the notallowed-NES indication and ignore the received cellBarred indication. If the notallowed-NES is set to “true”, the new UE identifies that the cell is barred, e.g. for the new UE; and if the notallowed-NES is set to “false”, the new UE identifies that the cell is not barred, e.g. for the new UE.

In addition, new UEs can be classified as new UEs without specific traffics (e.g. latency critical traffics), and new UEs with specific traffics (e.g. latency critical traffics). The new UE with specific traffics (e.g. latency critical traffics) may identify the cell status in the same way as legacy UE. It means that new UEs with specific traffics (e.g. latency critical traffics) can receive and identify the legacy cellBarred indication, while new UEs without specific traffics (e.g. latency critical traffics) receive and identify the notallowed-NES indication. So, the cell status explained in Table 2 can be alternatively explained in Table 3.

TABLE 3

| | | cell status to | |
|---|---|---|---|
| | | legacy UE and | cell status |
| | | new UE with | to new UE |
| | | specific | without specific |
| | | traffics (e.g. | traffics (e.g. |
| cellBarred | notallowed-NES | latency critical | latency critical |
| indication | indication | traffics) | traffics) |
| “barred” | “true” | cell is barred | cell is barred |
| “barred” | “false” | cell is barred | cell is not barred |
| “not barred” | “true” | cell is not barred | cell is barred |
| “not barred” | “false” | cell is not barred | cell is not barred |

According to the combination of the cellBarred indication and the notallowed-NES indication (e.g. the cellBarred indication set to “barred” and the notallowed-NES indication set to “false”), the new cell that is not in the normal state (e.g. the new cell implements Rel-18 network energy savings techniques and can be not in non-sleep state, which means that the new cell is in sleep state or in any of the multiple sleep states or in energy saving mode or in lower level of energy consumption) or that does not provide service to the legacy UEs or that is a non-anchor cell (e.g. the cell is in a non-anchor carrier) can be configured to be barred to legacy UEs but be accessible to new UEs (or be barred to legacy UEs and new UEs with specific traffics (e.g. latency critical traffics) but be accessible to new UEs without specific traffics (e.g. latency critical traffics)).

According to a second sub-embodiment of the first embodiment, the legacy intraFreqReselection indication may be ignored by both the legacy UE and the new UE.

In legacy, if a cell is barred to be accessed (e.g. by the cellBarred indication set to “barred”), the intraFreqReselection indication indicates to the UE whether it is allowed for the UE to select other cells on the same frequency as the barred cell. That is, if intraFreqReselection indication in the received MIB is set to “Allowed”, the UE considers that cell re-selection to other cells on the same frequency as the barred cell is allowed, while if intraFreqReselection indication in the received MIB is set to “notAllowed”, the UE considers that cell re-selection to other cells on the same frequency as the barred cell is not allowed (that is, the UE shall select other cells on a different frequency).

According to the second sub-embodiment of the first embodiment, if a cell is barred to be accessed (e.g. identified by the cellBarred indication set to “barred” for the legacy UE or for the legacy UE and the new UE with specific traffics (e.g. latency critical traffics), or identified by the notallowed-NES indication set to “true” for the new UE or for the new UE without specific traffics (e.g. latency critical traffics)), both the legacy UE and the new UE (with or without specific traffics (e.g. latency critical traffics)) ignore the intraFreqReselection indication. It means that both the legacy UE and the new UE consider that the intraFreqReselection indication is set to “Allowed”.

Incidentally, the cell being barred may not be explicitly indicated (e.g. by the cellBarred indication and/or by the notallowed-NES indication). It means that the cell being barred may be implicitly indicated. For example, reduced SSB may implicitly indicate the cell being barred for UEs with specific traffics (e.g. latency critical traffics).

According to a variety of the second sub-embodiment of the first embodiment, the legacy UE (or the legacy UE and the new UE with specific traffics) considers the intraFreqReselection indication, while the new UE (or the new UE without specific traffics) ignores the intraFreqReselection indication (i.e. consider that the intraFreqReselection indication is set to “Allowed”). For example, the actions upon reception of the MIB specified in TS 38.311 can be modified as follows (with modification (i.e. addition) underlined)

### Upon Receiving the MIB the UE Shall:

1> store the acquired MIB;
1> if the UE is in RRC_IDLE or in RRC_INACTIVE, or if the UE is in RRC_CONNECTED while T311 is running:
   2> if the cellBarred in the acquired MIB is set to barred:
      3> consider the cell as barred in accordance with TS 38.304 [20];
      3> if intraFreqReselection is set to notAllowed; and
      3> if the cell operates in licensed spectrum or the cell belongs to a PLMN which is indicated as being equivalent to the registered PLMN or the cell belongs to the registered SNPN of the UE:
         4> consider cell re-selection to other cells on the same frequency as the barred cell as not allowed, as specified in TS 38.304 [20].
         4> If the UE is a new UE, consider cell re-selection to other new cells on the same frequency as the barred cell as allowed.

According to a third sub-embodiment of the first embodiment, a new intraFreqReselection-NES indication may be added for the new UE (or for the new UE without specific traffics).

The intraFreqReselection-NES indication can be set to “notAllowed”, which means that that cell re-selection to other cells (or other new cells) on the same frequency as the barred cell is not allowed, or “Allowed”, which means that that cell re-selection to other cells (or other new cells) on the same frequency as the barred cell is allowed.

If the cell is barred (e.g. indicated by either the legacy cellBarred indication set to “barred” or the notallowed-NES indication set to “true”), if the intraFreqReselection-NES indication is set to “notAllowed”, the new UE considers cell re-selection to other cells on the same frequency as the barred cell as not allowed, or cell re-selection to other new cells on the same frequency as the barred cell as not allowed.

If the cell is barred (e.g. indicated by either the legacy cellBarred indication set to “barred” or the notallowed-NES indication set to “true”), if the intraFreqReselection-NES indication is not set (or is set to “Allowed”), the new UE considers cell re-selection to other cells on the same frequency as the barred cell as allowed, or cell re-selection to other new cells on the same frequency as the barred cell as allowed.

The new UE (or the new UE without specific traffics) may ignore the legacy intraFreqReselection indication if it receives the new intraFreqReselection-NES indication.

A second embodiment relates to enhancement of the second mechanism of UAC.

In legacy UAC, if the UAC-BarringPerCatList contains a UAC-BarringPerCat entry corresponding to the Access Category, the UAC-BarringPerCat entry is selected. The UAC-BarringPerCatList, which is an information element (IE), provides access control parameters for a list of access categories as follows:

### UAC-BarringPerCatList Information Element

-- ASN1START
-- TAG-UAC-BARRINGPERCATLIST-START

| | |
|---|---|
| UAC-BarringPerCatList ::= | SEQUENCE (SIZE (1..maxAccessCat-1)) OF UAC-BarringPerCat |
| UAC-BarringPerCat ::= | SEQUENCE { |
| accessCategory | INTEGER (1..maxAccessCat-1), |
| uac-barringInfoSetIndex | UAC-BarringInfoSetIndex |

}
-- TAG-UAC-BARRINGPERCATLIST-STOP
-- ASN1STOP

If the UAC-BarringInfoSetList contains a UAC-BarringInfoSet entry corresponding to the selected uac-barringInfoSetIndex in the UAC-BarringPerCat, the UAC-BarringInfoSet entry is selected. The UAC-BarringInfoSetList, which is an information element (IE), provides a list of access control parameter sets as follows. An access category can be configured with access parameters according to one of the sets.

### UAC-BarringInfoSetList Information Element

-- ASN1START
-- TAG-UAC-BARRINGINFOSETLIST-START

| | |
|---|---|
| UAC-BarringInfoSetList ::= | SEQUENCE (SIZE(1..maxBarringInfoSet)) OF UAC-BarringInfoSet |
| UAC-BarringInfoSet ::= | SEQUENCE { |
| uac-BarringFactor | ENUMERATED {p00, p05, p10, p15, p20, p25, p30, p40, |
| | p50, p60, p70, p75, p80, p85, p90, p95}, |
| uac-BarringTime | ENUMERATED {s4, s8, s16, s32, s64, s128, s256, s512}, |
| uac-BarringForAccessIdentity | BIT STRING (SIZE(7)) |

}
-- TAG-UAC-BARRINGINFOSETLIST-STOP
-- ASN1STOP

Access barring check is performed for the Access Category, using the selected UAC-BarringInfoSet as “UAC barring parameter”.

One or more Access Identities are indicated. If, for at least one of these indicated Access Identities, the corresponding bit in the uac-BarringForAccessIdentity contained in “UAC barring parameter” is set to zero, the access attempt is considered as allowed.

According to the second embodiment, three enhancements are proposed: (1) new AIs (for new UEs) are defined; (2) new ACs (for new UEs) are defined; (3) new parameters (for new UEs) are defined in existing AI(s) or existing AC(s).

According to a first sub-embodiment of the second embodiment, new Als are defined.

For example, a new AI (e.g. ‘k’) can be newly defined to indicate new UE. Alternatively, multiple new Als can be newly defined for the new UE to distinguish from legacy UE. For example, legacy AI=1 indicates UE (i.e. legacy UE) is configured for multimedia priority service (MPS). Accordingly, new AI=20 can be newly defined to indicate that new UE is configured for multimedia priority service (MPS). This can be applied when the new cell is not in the normal state or when the new cell is in sleep state or one of the multiple sleep states or when the new cell is in any state.

In addition, a new AI (e.g. ‘p’) can be newly defined to indicate new UE without specific traffics (e.g. latency critical traffics).

So, if one or more Access Identities are indicated (e.g. ‘k’ and ‘p’ are indicated), and if, for at least one of these Access Identities, the corresponding bit in the uac-BarringForAccessIdentity contained in “UAC barring parameter” (for example, ‘p’) is set to zero, the access attempt is considered as allowed.

According to a second sub-embodiment of the second embodiment, new ACs are defined.

One or more new ACs can be newly defined to indicate the legacy or new access categories for the new UE. This can be applied when the new cell is not in the normal state or when the new cell is in sleep state or one of the multiple sleep states or when the new cell is in any state.

The new ACs can be added to a list of access categories to provide access control parameters for the new ACs. For example, the legacy UAC-BarringPerCatList can be extended to include the new ACs. The corresponding access control parameters can be provided to each of the new ACs.

For example, AC values 0˜63 have been occupied and AC=1 is defined for delay tolerant in legacy (for legacy UE). New AC with value 70 can be added for delay tolerant for new UE.

The new UE can perform access barring check based on the new ACs.

According to a third embodiment of the second embodiment, new parameters (for new UEs) are defined in existing AI or AC. This can be applied when the new cell is not in the normal state or when the new cell is in sleep state or one of the multiple sleep states or when the new cell is in any state.

New parameters (access control parameters) can share the same entry with an existing AC. For example, new parameters can be added in an existing UAC-BarringInfoSet as follows (newly added parameters are underlined):

| | |
|---|---|
| UAC-BarringInfoSet ::= | SEQUENCE { |
| uac-BarringFactor | ENUMERATED {p00, p05, p10, p15, p20, p25, p30, p40, |
| | p50, p60, p70, p75, p80, p85, p90, p95}, |
| uac-BarringTime | ENUMERATED {s4, s8, s16, s32, s64, s128, s256, s512}, |
| uac-BarringForAccessIdentity | BIT STRING (SIZE(7)) |

```
  uac-Barring Factor-NES ENUMERATED {p00, p05, p10, p15, p20, p25, p30, p40,
                                                p50, p60, p70, p75, p80, p85, p90, p95},
  uac-BarringTime-NES ENUMERATED {s4, s8, s16, s32, s64, s128, s256, s512},
  uac-BarringForAccessIdentity-NES BIT STRING (SIZE(7))
}
```

Alternatively, new parameters can be added in a specific entry. For example, the specific entry can be added in an existing UAC-BarringPerCat as follows (specific entry is underlined):

| | |
|---|---|
| UAC-BarringPerCat ::= | SEQUENCE { |
| accessCategory | INTEGER (1..maxAccessCat-1), |
| uac-barringInfoSetIndex | UAC-BarringInfoSetIndex |

uac-barringInfoSetIndex-NES UAC-BarringInfoSetIndex
}

Further alternatively, the UAC-BarringPerCat can be extended to UAC-BarringPerCat-NES as follows:

| | |
|---|---|
| UAC-BarringPerCat-NES ::= | SEQUENCE { |
| accessCategory | INTEGER (1..maxAccessCat-1), |
| uac-barringInfoSetIndex | UAC-BarringInfoSetIndex |

}

For different cell states (e.g. different levels of sleep states such as micro sleep state, light sleep state, and deep sleep state), different access control parameters can be set. For example, different uac-BarringFactor corresponding to different uac-barringInfoSetIndex-NES, or different uac-BarringTime corresponding to different uac-barringInfoSetIndex-NES, or different uac-BarringFactor-NES, different uac-BarringTime-NES and/or different uac-BarringForAccessIdentity-NES can be set. For example, uac-BarringFactor can be set to 60% for light sleep state, while to 80% for deep sleep state, or uac-BarringFactor-NES can be set to 60% for light sleep state, while to 80% for deep sleep state.

A third embodiment relates to separate RACH resources.

Separate RACH resources may be configured for legacy UEs and new UEs. The separate RACH resources may refer to separate preambles, separate preamble groups, and/or separate RACH occasions.

The separate RACH resources may be broadcasted by system information, or configured by the dedicated signaling, or pre-defined in the specification, or configured as a default configuration.

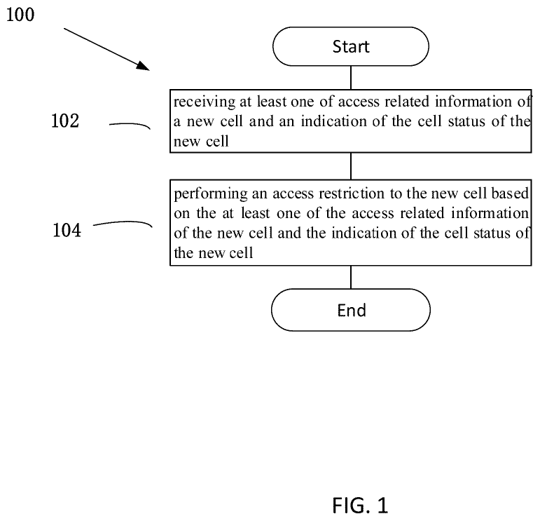

FIG. 1 is a schematic flow chart diagram illustrating an embodiment of a method 100 according to the present application. In some embodiments, the method 100 is performed by an apparatus, such as a remote unit (UE). In certain embodiments, the method 100 may be performed by a processor executing program code, for example, a microcontroller, a microprocessor, a CPU, a GPU, an auxiliary processing unit, a FPGA, or the like.

The method 100 may be performed by a UE and comprise 102 receiving at least one of access related information of a new cell and an indication of the cell status of the new cell; and 104 performing an access restriction to the new cell based on the at least one of the access related information of the new cell and the indication of the cell status of the new cell.

In some embodiment, the access related information of the new cell includes at least one of new AI, new AC, and new parameters defined in existing AI or AC for new UE.

In some embodiment, the UE is a new UE or a new UE without specific traffics.

In some embodiment, the indication of the cell status of the new cell includes at least one of an indication of the cell status of the new cell for legacy UE and an indication of the cell status of the new cell for new UE. If the new cell is not in normal state, or the new cell is not for access, or the new cell is a non-anchor cell, then, the cell status of the new cell for legacy UE is “barred” and the cell status of the new cell for new UE is “not barred”.

In some embodiment, if the indication of the cell status of the new cell is “not barred”, the access restriction to the new cell is performed based on the access related information of the new cell.

In some embodiment, the method further comprises receiving at least one of a cell reselection indication for new UE and a cell reselection indication for legacy UE, the cell reselection indication for the new UE indicates, if the indication of the cell status of the new cell indicates “barred” for the new UE, whether the new UE is allowed to reselect other cells on the same frequency as the barred cell, and the cell reselection indication for the legacy UE indicates, if the indication of the cell status of the new cell indicates “barred” for the legacy UE, whether the legacy UE is allowed to reselect other cells on the same frequency as the barred cell.

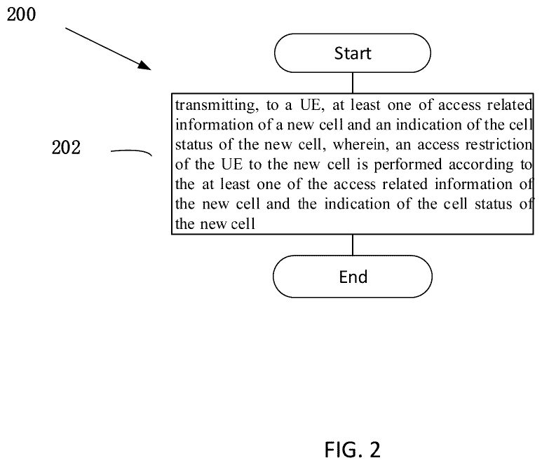

FIG. 2 is a schematic flow chart diagram illustrating a further embodiment of a method 200 according to the present application. In some embodiments, the method 200 is performed by an apparatus, such as a base unit or a network device. In certain embodiments, the method 200 may be performed by a processor executing program code, for example, a microcontroller, a microprocessor, a CPU, a GPU, an auxiliary processing unit, a FPGA, or the like.

The method 200 may be performed by a base unit and comprises 202 transmitting, to a UE, at least one of access related information of a new cell and an indication of the cell status of the new cell, wherein, an access restriction of the UE to the new cell is performed according to the at least one of the access related information of the new cell and the indication of the cell status of the new cell.

In some embodiment, the access related information of the new cell includes at least one of new AI, new AC, and new parameters defined in existing AI or AC for new UE.

In some embodiment, the access restriction of a new UE or a new UE without specific traffics to the new cell is performed.

In some embodiment, the indication of the cell status of the new cell includes at least one of an indication of the cell status of the new cell for legacy UE and an indication of the cell status of the new cell for new UE. If the new cell is not in normal state, or the new cell is not for access, or the new cell is a non-anchor cell, then, the cell status of the new cell for legacy UE is “barred” and the cell status of the new cell for new UE is “not barred”.

In some embodiment, different access control parameters are configured to access related information of the new cell depending on different states of the new cell.

In some embodiment, the method further comprises transmitting, to the UE, at least one of a cell reselection indication for new UE and a cell reselection indication for legacy UE, the cell reselection indication for the new UE indicates, if the indication of the cell status of the new cell indicates “barred” for the new UE, whether the new UE is allowed to reselect other cells on the same frequency as the barred cell, and the cell reselection indication for the legacy UE indicates, if the indication of the cell status of the new cell indicates “barred” for the legacy UE, whether the legacy UE is allowed to reselect other cells on the same frequency as the barred cell.

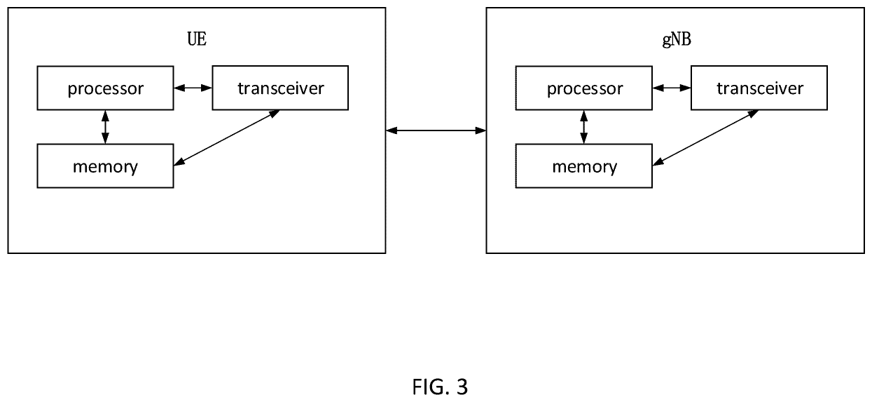

FIG. 3 is a schematic block diagram illustrating apparatuses according to one embodiment.

Referring to FIG. 3, the UE (i.e. remote unit, or terminal device) includes a processor, a memory, and a transceiver. The processor implements a function, a process, and/or a method which are proposed in FIG. 1.

The UE comprises a processor; and a transceiver coupled to the processor, wherein, the processor is configured to receive, via the transceiver, at least one of access related information of a new cell and an indication of the cell status of the new cell; and perform an access restriction to the new cell based on the at least one of the access related information of the new cell and the indication of the cell status of the new cell.

In some embodiment, the access related information of the new cell includes at least one of new AI, new AC, and new parameters defined in existing AI or AC for new UE.

In some embodiment, the UE is a new UE or a new UE without specific traffics.

In some embodiment, the indication of the cell status of the new cell includes at least one of an indication of the cell status of the new cell for legacy UE and an indication of the cell status of the new cell for new UE. If the new cell is not in normal state, or the new cell is not for access, or the new cell is a non-anchor cell, then, the cell status of the new cell for legacy UE is “barred” and the cell status of the new cell for new UE is “not barred”.

In some embodiment, if the indication of the cell status of the new cell is “not barred”, the access restriction to the new cell is performed based on the access related information of the new cell.

In some embodiment, the processor is further configured to receive, via the transceiver, at least one of a cell reselection indication for new UE and a cell reselection indication for legacy UE, the cell reselection indication for the new UE indicates, if the indication of the cell status of the new cell indicates “barred” for the new UE, whether the new UE is allowed to reselect other cells on the same frequency as the barred cell, and the cell reselection indication for the legacy UE indicates, if the indication of the cell status of the new cell indicates “barred” for the legacy UE, whether the legacy UE is allowed to reselect other cells on the same frequency as the barred cell.

Referring to FIG. 3, the gNB (i.e. base unit or network device) includes a processor, a memory, and a transceiver. The processor implements a function, a process, and/or a method which are proposed in FIG. 2.

The base unit comprises a processor; and a transceiver coupled to the processor, wherein, the processor is configured to transmit, via the transceiver, to a UE, at least one of access related information of a new cell and an indication of the cell status of the new cell, wherein, an access restriction of the UE to the new cell is performed according to the at least one of the access related information of the new cell and the indication of the cell status of the new cell.

In some embodiment, the access related information of the new cell includes at least one of new AI, new AC, and new parameters defined in existing AI or AC for new UE.

In some embodiment, the access restriction of a new UE or a new UE without specific traffics to the new cell is performed.

In some embodiment, the indication of the cell status of the new cell includes at least one of an indication of the cell status of the new cell for legacy UE and an indication of the cell status of the new cell for new UE. If the new cell is not in normal state, or the new cell is not for access, or the new cell is a non-anchor cell, then, the cell status of the new cell for legacy UE is “barred” and the cell status of the new cell for new UE is “not barred”.

In some embodiment, different access control parameters are configured to access related information of the new cell depending on different states of the new cell.

In some embodiment, the processor is further configured to transmit, via the transceiver, to the UE, at least one of a cell reselection indication for new UE and a cell reselection indication for legacy UE, the cell reselection indication for the new UE indicates, if the indication of the cell status of the new cell indicates “barred” for the new UE, whether the new UE is allowed to reselect other cells on the same frequency as the barred cell, and the cell reselection indication for the legacy UE indicates, if the indication of the cell status of the new cell indicates “barred” for the legacy UE, whether the legacy UE is allowed to reselect other cells on the same frequency as the barred cell.

Layers of a radio interface protocol may be implemented by the processors. The memories are connected with the processors to store various pieces of information for driving the processors. The transceivers are connected with the processors to transmit and/or receive a radio signal. Needless to say, the transceiver may be implemented as a transmitter to transmit the radio signal and a receiver to receive the radio signal.

The memories may be positioned inside or outside the processors and connected with the processors by various well-known means.

In the embodiments described above, the components and the features of the embodiments are combined in a predetermined form. Each component or feature should be considered as an option unless otherwise expressly stated. Each component or feature may be implemented not to be associated with other components or features. Further, the embodiment may be configured by associating some components and/or features. The order of the operations described in the embodiments may be changed. Some components or features of any embodiment may be included in another embodiment or replaced with the component and the feature corresponding to another embodiment. It is apparent that the claims that are not expressly cited in the claims are combined to form an embodiment or be included in a new claim.

The embodiments may be implemented by hardware, firmware, software, or combinations thereof. In the case of implementation by hardware, according to hardware implementation, the exemplary embodiment described herein may be implemented by using one or more application-specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and the like.

Embodiments may be practiced in other specific forms. The described embodiments are to be considered in all respects to be only illustrative and not restrictive. The scope of the invention is, therefore, indicated by the appended claims rather than by the foregoing description. All changes which come within the meaning and range of equivalency of the claims are to be embraced within their scope.

1. A user equipment (UE) for wireless communication, the UE comprising:
at least one memory; and
at least one processor coupled with the at least one memory and configured to cause the UE to:
receive at least one of access related information of a new cell and an indication of a cell status of the new cell; and
perform an access restriction to the new cell based on the at least one of the access related information of the new cell and the indication of the cell status of the new cell.

2. The UE of claim 1, wherein, the access related information of the new cell includes at least one of a new access identity (AI), a new access category (AC), and new parameters defined in existing Als or ACs for new UEs.

3. The UE of claim 1, wherein, the UE is a new UE or a new UE without specific traffics.

4. The UE of claim 1, wherein, the indication of the cell status of the new cell includes at least one of an indication of the cell status of the new cell for legacy UEs and an indication of the cell status of the new cell for new UEs.

5. The UE of claim 4, wherein, when the new cell is not in a normal state, or the new cell is not for access, or the new cell is a non-anchor cell, the cell status of the new cell for legacy UEs is barred and the cell status of the new cell for new UEs is not barred.

6. The UE of claim 1, wherein, when the indication of the cell status of the new cell is not barred, the access restriction to the new cell is performed based on the access related information of the new cell.

7. The UE of claim 1, wherein the least one processor is further configured to cause the UE to:
receive at least one of a cell reselection indication for new UEs and a cell reselection indication for legacy UEs,
wherein the cell reselection indication for new UEs indicates, when the indication of the cell status of new cells indicates barred for new UEs, whether new UEs are allowed to reselect other cells on the same frequency as the barred cell, and
wherein the cell reselection indication for legacy UEs indicates, when the indication of the cell status of the new cell indicates barred for legacy UEs, whether legacy UEs are allowed to reselect other cells on the same frequency as the barred cell.

8. A method performed by a user equipment (UE), the method comprising:
receiving at least one of access related information of a new cell and an indication of a cell status of the new cell; and
performing an access restriction to the new cell based on the at least one of the access related information of the new cell and the indication of the cell status of the new cell.

9. A base unit for wireless communication, comprising:
at least one memory; and
at least one processor coupled with the at least one memory and configured to cause the base unit to:
transmit to a user equipment (UE), at least one of access related information of a new cell and an indication of a cell status of the new cell,
wherein, an access restriction of the UE to the new cell is performed according to the at least one of the access related information of the new cell and the indication of the cell status of the new cell.

10. The base unit of claim 9, wherein, the access related information of the new cell includes at least one of a new access identity (AI), a new access category (AC), and new parameters defined in existing Als or ACs for new UEs.

11. The base unit of claim 9, wherein, the at least one processor is further configured to cause the base unit to perform the access restriction of a new UE or a new UE without specific traffics to the new cell.

12. The base unit of claim 9, wherein, the indication of the cell status of the new cell includes at least one of an indication of the cell status of the new cell for legacy UEs and an indication of the cell status of the new cell for new UEs.

13. The base unit of claim 12, wherein, when the new cell is not in a normal state, or the new cell is not for access, or the new cell is a non-anchor cell, the cell status of the new cell for legacy UEs is barred and the cell status of the new cell for new UEs is not barred.

14. The base unit of claim 9, wherein, different access control parameters are configured to access related information of the new cell depending on different states of the new cell.

15. The base unit of claim 9, wherein the at least one processor is further configured to cause the base unit to:
transmit to the UE at least one of a cell reselection indication for new UEs and a cell reselection indication for legacy UEs,
wherein the cell reselection indication for new UEs indicates, when the indication of the cell status of the new cell indicates barred for the new UEs, whether new UEs are allowed to reselect other cells on the same frequency as the barred cell, and
wherein the cell reselection indication for legacy UEs indicates, when the indication of the cell status of the new cell indicates barred for legacy UEs, whether legacy UEs are allowed to reselect other cells on the same frequency as the barred cell.

16. A method performed by a base unit, the method comprising:
transmitting, to a user equipment (UE), at least one of access related information of a new cell and an indication of a cell status of the new cell,
wherein an access restriction of the UE to the new cell is performed according to the at least one of the access related information of the new cell and the indication of the cell status of the new cell.

17. The method of claim 16, wherein the access related information of the new cell includes at least one of a new access identity (AI), a new access category (AC), and new parameters defined in existing AIs or ACs for new UEs.

18. The UE of claim 5, wherein the cell status of the new cell for new UEs is indicated by an additional indication.

19. The UE of claim 21, wherein the new indication is included in a system information block Type 1 (SIB1).

20. The UE of claim 1, wherein the new cell is in a sleep state, including a non-active state or a low energy consumption state.
